(19) United States
(12) Patent Application Publication
(10) Pub. No.: US 2025/0340116 A1
(43) Pub. Date: Nov. 6, 2025

(54) UNIFICATION OF ACCESS TO VEHICLE PROPERTY DATA AND HMI APPLICATION SPECIFIC DATA

(71) Applicant: TOYOTA JIDOSHA KABUSHIKI KAISHA, Aichi-ken (JP)

(72) Inventors: Toshiyuki AGA, Ota-ku (JP); Hideto KIMURA, Kobe-shi (JP)

(21) Appl. No.: 18/652,771

(22) Filed: May 1, 2024

(51) Int. Cl. B60K 35/00; H04L 67/12

(52) U.S. Cl. CPC B60K 35/00; H04L 67/12

(57) ABSTRACT

Unification of access to vehicle property data and HMI application specific data is performed by receiving, from an HMI application, a request to read data, determining whether the request is for property data, transmitting a requested value among the plurality of values stored in the first file path in response to determining that the request is for property data, and transmitting requested data among application specific data stored in a second file path in response to determining that the request is not for property data.

### BACKGROUND

Property data includes predetermined metrics or parameters that dynamically change during operation depending on user settings or vehicle conditions, such as vehicle speed, fuel level, engine RPMs, number of connected devices, etc. Property data is gathered by a property manager by communicating with various sensors using various Application Programming Interfaces (APIs), converted into a common format by the property manager, and stored in a predetermined directory.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for unification of access to vehicle property data and HMI application specific data, according to at least some embodiments of the subject disclosure.

FIG. 2 is an operational flow for unification of access to vehicle property data and HMI application specific data, according to at least some embodiments of the subject disclosure.

FIG. 3 is an operational flow for property data retrieval, according to at least some embodiments of the subject disclosure.

FIG. 4 is an operational flow for data recording, according to at least some embodiments of the subject disclosure.

FIG. 5 is a block diagram of a hardware configuration for unification of access to vehicle property data and HMI application specific data, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In vehicle systems known to the inventors, the property manager makes the property data available upon request through a single API. Human Machine Interface (HMI) applications, including those of third parties, have access to read and write property data through the property manager's API. However, at least some HMI applications benefit from an ability to store data other than predetermined property data, such as account data, user information, etc.

In at least some embodiments described herein, the functionality of the property manager is extended to enable HMI applications to read and write application-specific data in the same manner as property data. In at least some embodiments, the property manager responds to API commands for data other than property data, enabling HMI applications to read and write property data and application-specific data in the same manner.

In at least some embodiments, a system in a vehicle enables HMI applications to read and write application-specific data through the same API that is used to read and write property data, such as vehicle speed, remaining fuel, engine RPM, etc., by writing application-specific data to a different file path than the property data. In this manner, at least some embodiments herein enable HMI applications to write and read data other than property data without requiring another API command set.

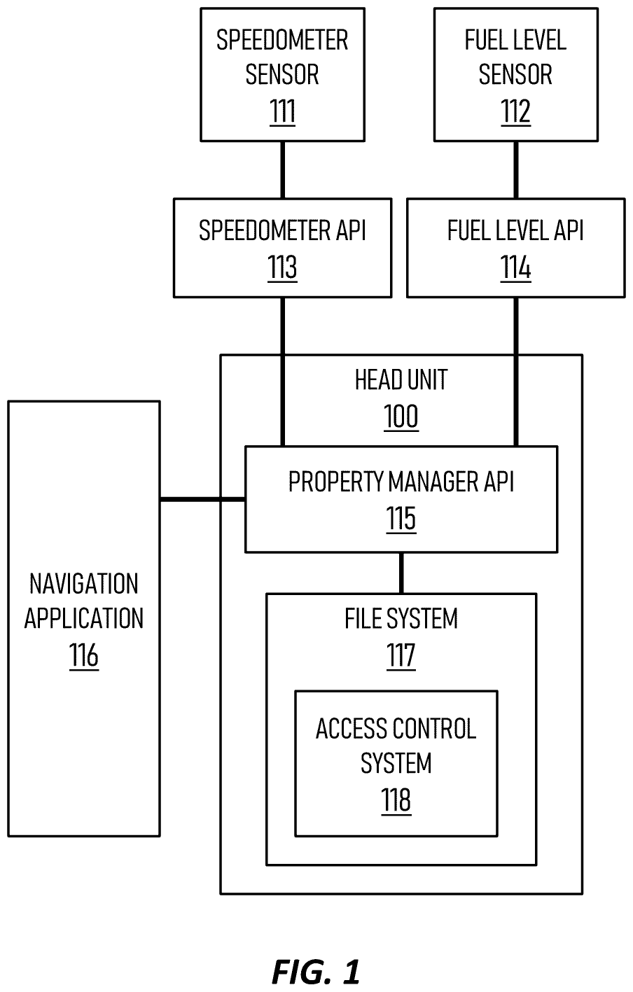

FIG. 1 is a schematic diagram of a system for unification of access to vehicle property data and HMI application specific data, according to at least some embodiments of the subject disclosure. The system includes head unit 100, speedometer sensor 111, fuel level sensor 112, speedometer API 113, fuel level API 114, property manager API 115, navigation application 116, file system 117, and access control system 118.

Head unit 100 is in communication with speedometer API 113, fuel level API 114, and navigation application 116, and includes property manager API 115, file system 117, and access control system 118. In at least some embodiments, head unit 100 is configured to serve as the central processing unit for the vehicle's HMI applications. In at least some embodiments, head unit 100 is configured to facilitate the exchange of data between various APIs and HMI applications. In at least some embodiments, head unit 100 is configured to interact with various APIs and HMI applications similar to how a computer's CPU interacts with software. In at least some embodiments, head unit 100 is the infotainment system in a vehicle, such as an automobile. In at least some embodiments, head unit 100 includes a touchscreen interface. In at least some embodiments, head unit 100 is configured to provide an interface for drivers and passengers to interact with systems of a vehicle. In at least some embodiments, head unit 100 is configured to provide navigation, media playback, and vehicle settings through HMI applications. In at least some embodiments, head unit 100 is configured for data management and security.

Speedometer sensor 111 is in communication with speedometer API 113. In at least some embodiments, speedometer sensor 111 is in communication with a vehicle's wheels or transmission. In at least some embodiments, speedometer sensor 111 includes components similar to speed sensors found in most vehicles. In at least some embodiments, speedometer sensor 111 is configured to measure the vehicle's speed. In at least some embodiments, speedometer sensor 111 is configured to make real-time speed data available for retrieval or processing. In at least some embodiments, speedometer sensor 111 is configured to interact with speedometer API 113. In at least some embodiments, speedometer sensor 111 includes mechanical and/or electronic components to measure the rotation speed of the vehicle's wheels or transmission. In at least some embodiments, data from speedometer sensor 111 is used to display the speed of a vehicle on a dashboard. In at least some embodiments, data from speedometer sensor 111 is utilized by cruise control systems. In at least some embodiments, speedometer sensor 111 is configured to interact with speedometer API 113 to make speed data available for retrieval to be processed and utilized by various HMI applications.

Fuel level sensor 112 is in communication with fuel level API 114. In at least some embodiments, fuel level sensor 112 is configured to measure the fuel level. In at least some embodiments, fuel level sensor 112 is configured to measure the remaining fuel in the vehicle. In at least some embodiments, fuel level sensor 112 is further configured to provide data on the vehicle's fuel status. In at least some embodiments, fuel level sensor 112 communicates with fuel level API 114. In at least some embodiments, fuel level sensor 112 is similar to a fuel gauge sender in a vehicle's fuel tank. In at least some embodiments, fuel level sensor 112 includes mechanical and/or electronic components to measure the fuel level. In at least some embodiments, fuel level sensor 112 produces data usable to alert a driver in response to a vehicle being low on fuel. In at least some embodiments, fuel level sensor 112 communicates data to fuel level API 114.

Speedometer API 113 is in communication with speedometer sensor 111 and head unit 100. In at least some embodiments, speedometer API 113 is configured to retrieve vehicle speed data from speedometer sensor 111. In at least some embodiments, speedometer API 113 is configured to communicate this data to head unit 100. In at least some embodiments, speedometer API 113 is similar to software interfaces found in an Electronic Control Unit (ECU) of a vehicle. In at least some embodiments, data from speedometer API 113 is utilized by HMI applications after being processed in head unit 100. In at least some embodiments, data from speedometer API 113 is used by navigation application 116 to calculate an Estimated Time of Arrival (ETA). In at least some embodiments, speedometer API 113 is used by a driver assistance system to maintain a set speed.

Fuel level API 114 is in communication with fuel level sensor 112 and head unit 100. In at least some embodiments, fuel level API 114 is configured to retrieve remaining fuel data from fuel level sensor 112. In at least some embodiments, fuel level API 114 is configured to communicate this data to head unit 100 for processing and retrieval by HMI applications. In at least some embodiments, fuel level API 114 is configured to communicate with fuel level sensor 112 to retrieve fuel data. In at least some embodiments, fuel level API 114 is configured to send this data to head unit 100 upon request. In at least some embodiments, fuel level API 114 is similar to software interfaces found in an ECU of a vehicle. In at least some embodiments, fuel level API 114 is a software interface. In at least some embodiments, data from fuel level API 114 is usable by a fuel economy application to provide insights on fuel consumption and efficiency.

Property manager API 115 is in communication with navigation application 116 and is included in head unit 100. In at least some embodiments, property manager API 115 is configured as a software interface. In at least some embodiments, property manager API 115 is configured to enable HMI applications, such as navigation application 116, to communicate with head unit 100. In at least some embodiments, property manager API 115 is configured to facilitate the exchange of data between head unit and various HMI applications. In at least some embodiments, property manager API 115 enables different vehicle components and systems to interact. In at least some embodiments, property manager API 115 is configured to enable interaction similar to how APIs function within a computer system. In at least some embodiments, property manager API 115 is configured to support Representational State Transfer (REST) commands.

Navigation application 116 is in communication with head unit 100. In at least some embodiments, navigation application 116 is configured to use property data of a vehicle to provide navigation information, such as to the driver. In at least some embodiments, navigation application 116 is configured to provide navigation instructions based on vehicle data. In at least some embodiments, navigation application 116 receives vehicle data from head unit 100. In at least some embodiments, navigation application 116 is a GPS navigation application for a vehicle. In at least some embodiments, navigation application 116 is an HMI application. In at least some embodiments, navigation application 116 is configured to provide real-time navigation assistance to the driver. In at least some embodiments, navigation application 116 provides turn-by-turn directions. In at least some embodiments, navigation application 116 provides traffic updates. In at least some embodiments, navigation application 116 provides points of interest.

File system 117 is in communication with property manager API 115. In at least some embodiments, file system 117 is configured to organize and store data. In at least some embodiments, file system 117 is configured to store data in various file paths. In at least some embodiments, file system 117 is configured to store property data in one file path, and application-specific data in one or more other file paths. In at least some embodiments, file system 117 interacts with HMI applications and other components through property manager API 115. In at least some embodiments, file system 117 is similar to file systems found in computer operating systems. In at least some embodiments, file system 117 utilizes a memory or other form of physical electronic storage. In at least some embodiments, file system 117 is configured to store user preferences. In at least some embodiments, file system 117 is configured to store navigation data. In at least some embodiments, file system 117 is configured to store media files.

Access control system 118 is included in file system 117. In at least some embodiments, access control system 118 is configured to manage access to predetermined file paths in file system 117. In at least some embodiments, access control system 118 is configured to facilitate secure storage and access of data. In at least some embodiments, access control system 118 interacts with file system 117. In at least some embodiments, access control system 118 is similar to access control mechanisms found in computer operating systems. In at least some embodiments, access control system 118 is configured to enable protection of sensitive data, such as vehicle speed, fuel level, user credentials, personal information, etc. In at least some embodiments, access control system 118 is configured to prevent unauthorized access to sensitive data.

In at least some embodiments, a system for unification of access to vehicle property data and HMI application specific data includes sensors and sensor APIs other than or in addition to those for speed and fuel level, such as engine RPMs, number of connected devices, illumination, etc. In at least some embodiments, the first sensor is one of a speedometer, a fuel sensor, or a tachometer. In at least some embodiments, a system for unification of access to vehicle property data and HMI application specific data includes HMI applications other than or in addition to those for navigation, such as media presentation, personal communication, interactive entertainment, emergency notification, etc. In at least some embodiments, the HMI application is one of a navigation application, a media application, or a user communication application. In at least some embodiments, a property manager API is included in components other than a head unit, such as a central unit, or any other ECU or computational device within a vehicle.

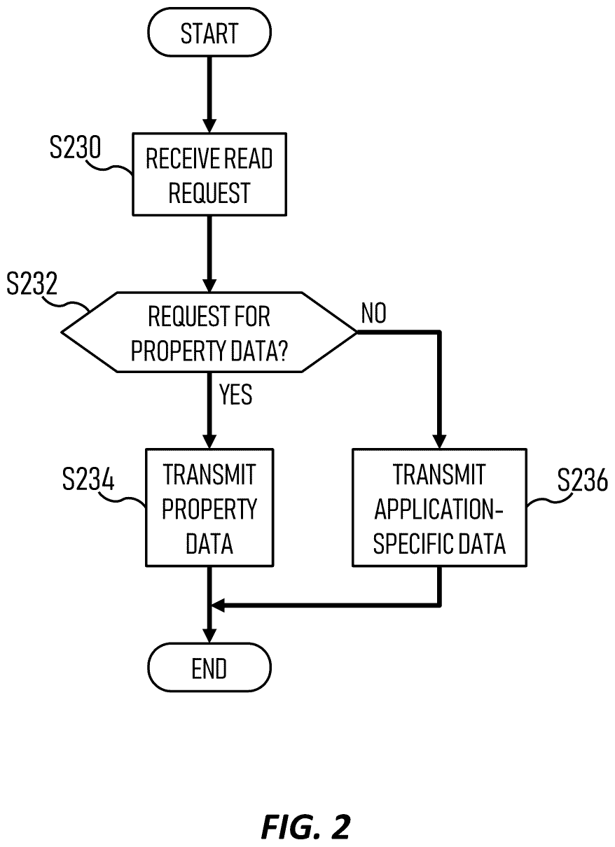

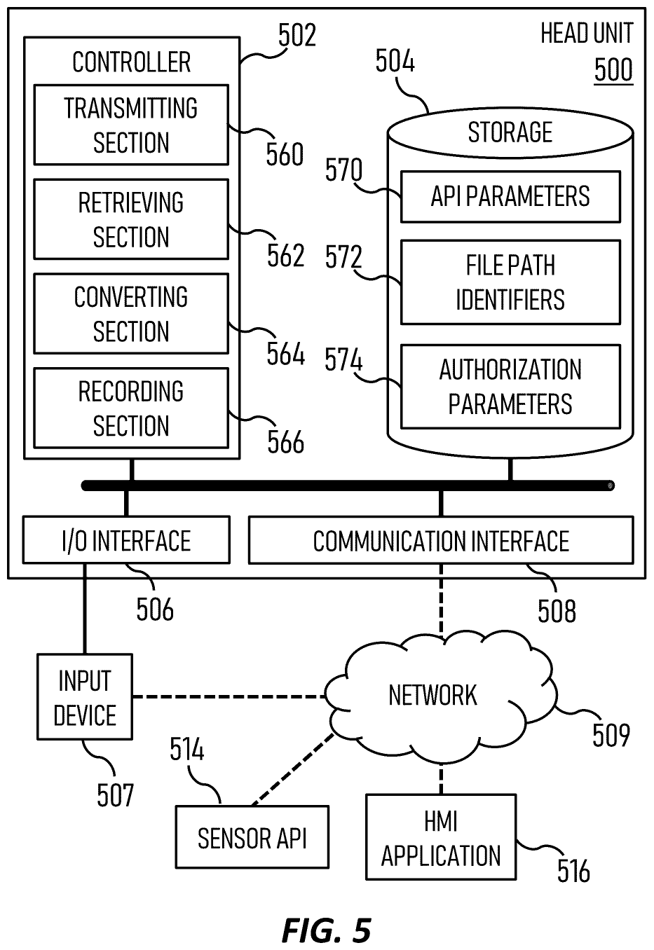

FIG. 2 is an operational flow for unification of access to vehicle property data and HMI application specific data, according to at least some embodiments of the subject disclosure. In at least some embodiments, the operational flow provides a method of unification of access to vehicle property data and HMI application specific data, according to at least some embodiments of the subject disclosure. In at least some embodiments, the method is performed by a controller of a head unit, such as controller 502 of head unit 500 of FIG. 5, described hereinafter.

At S230, the controller or a section thereof receives a read request. In at least some embodiments, the controller receives, from an HMI application, a request to read data. In at least some embodiments, the request is received through a property manager API. In at least some embodiments, a property manager API of the controller receives the read request. In at least some embodiments, the property manager API listens for incoming requests. In at least some embodiments, the read request is for property data or application-specific data. In at least some embodiments, the HMI application transmits the read request in response to performing an operation that utilizes vehicle data. In at least some embodiments, the controller parses the read request upon reception.

At S232, the controller or a section thereof determines whether the request is for property data. In at least some embodiments, the controller determines whether the request is for property data. In at least some embodiments, the controller determines based on a file path of the request. In at least some embodiments, the controller examines the parsed request. In at least some embodiments, the controller determines whether the request is for property data or other data, such as application-specific data. In response to the request being for property data, the operational flow proceeds to property data transmission at S234. In response to the request not being for property data, the operational flow proceeds to application-specific data transmission at S236.

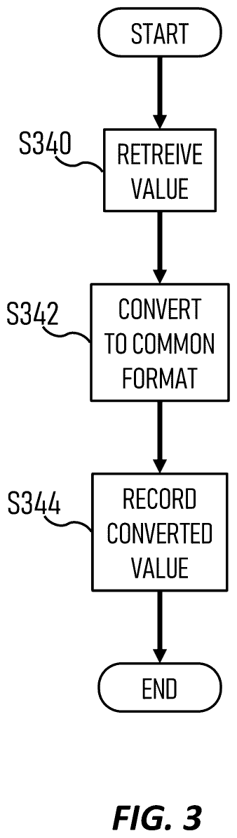

At S234, the controller or a section thereof transmits property data. In at least some embodiments, the controller transmits a requested value among a plurality of values stored in a first file path in response to determining that the request is for property data. In at least some embodiments, a property manager API of the controller transmits property data. In at least some embodiments, the controller retrieves the requested value from a file path dedicated to property data. In at least some embodiments, the controller transmits the requested value to a requesting HMI application. In at least some embodiments, the controller provides historical data corresponding to the requested data to the HMI application. In at least some embodiments, the controller transmits the requested value in response to determining that the request is for property data. In at least some embodiments, the controller performs the operational flow of FIG. 3, described hereinafter.

At S236, the controller or a section thereof transmits application-specific data. In at least some embodiments, the controller transmits requested data among application-specific data stored in a second file path in response to determining that the request is not for property data. In at least some embodiments, the application specific data is one of account data or user information. In at least some embodiments, a property manager API of the controller transmits application-specific data. In at least some embodiments, the controller retrieves the requested value from a file path other than the file path dedicated to property data. In at least some embodiments, controller transmits the requested value to a requesting HMI application. In at least some embodiments, the controller transmits the requested value in response to determining that the request is for data other than property data, i.e.—application-specific data. In at least some embodiments, the property manager API of the controller transmits the requested data to the HMI application. In at least some embodiments, the controller provides historical data corresponding to the requested data to the HMI application. In at least some embodiments, the controller performs the operational flow of FIG. 3, described hereinafter.

FIG. 3 is an operational flow for property data retrieval, according to at least some embodiments of the subject disclosure. In at least some embodiments, the operational flow provides a method of property data retrieval, according to at least some embodiments of the subject disclosure. In at least some embodiments, the operational flow is performed in response to a request from an HMI application. In at least some embodiments, the method is performed by a controller of a head unit, such as controller 502 of head unit 500 of FIG. 5, described hereinafter.

At S340, the controller or a section thereof retrieves a value. In at least some embodiments, the controller retrieves a first value through a first vehicle API. In at least some embodiments, the controller retrieves a second value through a second vehicle API. In at least some embodiments, the controller retrieves the value through a vehicle sensor API. In at least some embodiments, the controller initiates a request for a sensor value via the vehicle sensor API. In at least some embodiments, the controller retrieves the value in response to a change in vehicle status. In at least some embodiments, the first value is retrieved in response to a change notification received through the first vehicle API. In at least some embodiments, the first value is retrieved in response to the request to read data. In at least some embodiments, the first value is retrieved from a first vehicle sensor, and the second value is retrieved from a second vehicle sensor. In at least some embodiments, the vehicle sensor API processes the request. In at least some embodiments, the vehicle sensor API returns the requested value. In at least some embodiments, the controller retrieves a data value monitored by the vehicle or a sensor thereof. In at least some embodiments, the first value is one of a vehicle speed, an amount of fuel, an engine RPM, or a number of connected devices. In at least some embodiments, the controller retrieves the value in order to provide real-time, accurate data to a requesting HMI application.

At S342, the controller or a section thereof converts the retrieved value into a common format. In at least some embodiments, the controller converts at least one of the first value or the second value from a proprietary format into a common format. In at least some embodiments, the controller converts the retrieved value from a proprietary format into a common format. In at least some embodiments, different vehicle sensors use different data formats. In at least some embodiments, the controller converts the retrieved value so that HMI applications are able to interpret and use the value. In at least some embodiments, the controller parses a proprietary data format of the value. In at least some embodiments, the controller maps proprietary data elements of the value to corresponding elements in the common format. In at least some embodiments, the controller encodes the value into the common format.

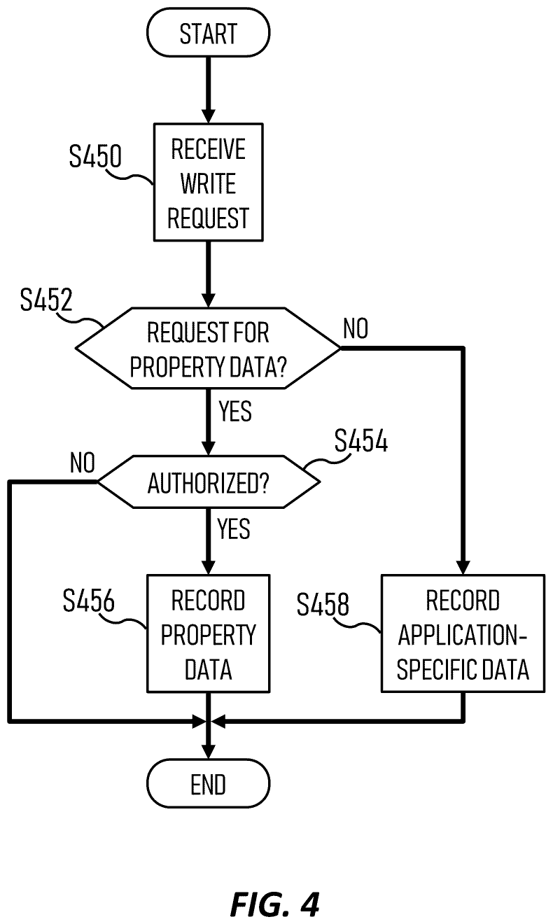

At S344, the controller or a section thereof records the converted value. In at least some embodiments, the controller records the first value and the second value to a first file path among a plurality of values. In at least some embodiments, the controller records the converted value to a file path dedicated to property data. In at least some embodiments, the controller records the converted value to an onboard storage system of the vehicle. In at least some embodiments, the controller records the converted value to a file path indicated in a request from an HMI application. In at least some embodiments, the controller overwrites a previously recorded value. In at least some embodiments, the controller maintains a previously recorded value. In at least some embodiments, the controller records the data in response to successfully converting the value. In at least some embodiments, the controller records the converted value to a file path that is protected with higher access restrictions. In at least some embodiments, the controller performs the operational flow of FIG. 4, described hereinafter.

FIG. 4 is an operational flow for data recording, according to at least some embodiments of the subject disclosure. In at least some embodiments, the operational flow provides a method of data recording, according to at least some embodiments of the subject disclosure. In at least some embodiments, the method is performed by a controller of a head unit, such as controller 502 of head unit 500 of FIG. 5, described hereinafter.

At S450, the controller or a section thereof receives a request to write data. In at least some embodiments, the controller receives a request to write data from an HMI application. In at least some embodiments, the controller receives, from an HMI application, a request to write data among the application specific data. In at least some embodiments, the controller listens for incoming requests from the HMI application through a property manager API. In at least some embodiments, the controller receives a request including data to be written. In at least some embodiments, the controller receives a request including metadata, such as a desired file path, a data format, authentication information, etc.

At S452, the controller or a section thereof determines whether the request is for property data. In at least some embodiments, the controller or a section thereof determines whether the request is for property data or application-specific data. In at least some embodiments, the controller determines based on a file path identifier, such as within metadata included in the request. In at least some embodiments, the request includes a file path identifier, and the controller determines based on the file path identifier. In at least some embodiments, the first file path has a higher access restriction than the second file path. In at least some embodiments, the request is for property data if the file path identifier corresponds to the first file path. In at least some embodiments, the controller determines that the request is for application-specific data in response to a file path identifier corresponding to a file path other than a file path dedicated to property data. In response to determining that the request is for property data, the operational flow proceeds to authorization determination at S454. In response to determining that the request is not for property data, the operational flow proceeds to application-specific data recording at S458.

At S454, the controller determines whether the request is authorized. In at least some embodiments, the controller determines whether the request includes authorization to record property data. In at least some embodiments, the controller determines whether the request is from an authorized HMI application. In at least some embodiments, the controller checks credentials of the HMI application. In at least some embodiments, the controller checks credentials against an access control list or similar security mechanism. In at least some embodiments, the controller allows only trusted applications to modify the property data of the vehicle. In response to determining that the request is authorized, the operational flow proceeds to property data recording at S456. In response to determining that the request is not authorized, the operational flow ends.

At S456, the controller or a section thereof records property data. In at least some embodiments, the controller records the property data to a file path dedicated to property data. In at least some embodiments, the controller writes the property data to a file system of the vehicle. In at least some embodiments, the controller updates system parameters or settings associated with the property data. In at least some embodiments, the controller records the property data in response to determining that the value is within a predetermined range.

At S458, the controller or a section thereof records application-specific data. In at least some embodiments, the controller records the data among the application-specific data to a second file path in response to the request to write the data among the application-specific data. In at least some embodiments, the controller records the application-specific data to a file path other than a file path dedicated to property data. In at least some embodiments, the controller records the application-specific data to an application-specific file path. In at least some embodiments, the controller writes the application-specific data to a file system of the vehicle. In at least some embodiments, the controller records the application-specific data so that the HMI application is able to retrieve the application-specific data from persistent storage. In at least some embodiments, recording the application-specific data is for maintaining user preferences, tracking usage statistics, or relieving entry of user credentials.

In at least some embodiments, an operational flow for data recording is performed in response to conditions other than a write requests from an HMI application, such as status update, a value request from an HMI application, etc. In at least some embodiments, the controller transmits an error message in response to determining that the request is not authorized. In at least some embodiments, the controller changes the file path identifier of the file path dedicated to property data, either periodically or in response to an event, as a security precaution. In at least some embodiments, the controller changes the file path identifier of the first file path in response to vehicle status. In at least some embodiments, the vehicle status is one of high speed, automated driving, or emergency situation.

FIG. 5 is a block diagram of a hardware configuration for unification of access to vehicle property data and HMI application specific data, according to at least some embodiments of the subject disclosure.

The exemplary hardware configuration includes head unit 500, which interacts with input device 507 directly or through network 509, and interacts with sensor API 514 and HMI application 516 through network 509. In at least some embodiments, input device 507 is a touch screen, a microphone, a camera, or any other device configured to detect tactile, aural, visual, etc. input. In at least some embodiments, network 509 is an ethernet network, a Controller Area Network (CAN), or any other wired or wireless network or a combination thereof. In at least some embodiments, head unit 500 is a computer or other computing device that receives input or commands from input device 507. In at least some embodiments, head unit 500 is integrated with input device 507. In at least some embodiments, head unit 500 is a computer system that executes computer-readable instructions to perform operations for unification of access to vehicle property data and HMI application specific data.

Head unit 500 includes a controller 502, a storage 504, an input/output interface 506, and a communication interface 508. In at least some embodiments, controller 502 includes a processor or programmable circuitry executing instructions to cause the processor or programmable circuitry to perform operations according to the instructions. In at least some embodiments, controller 502 includes analog or digital programmable circuitry, or any combination thereof. In at least some embodiments, controller 502 includes physically separated storage or circuitry that interacts through communication. In at least some embodiments, storage 504 includes a non-volatile computer-readable medium capable of storing executable and non-executable data for access by controller 502 during execution of the instructions. In at least some embodiments, communication interface 508 transmits and receives data from network 509. In at least some embodiments, input/output interface 506 connects to various input and output units, such as input device 507, via a parallel port, a serial port, a keyboard port, a mouse port, a monitor port, and the like to accept commands and present information. In some embodiments, storage 504 is external from head unit 500.

Controller 502 includes transmitting section 560, retrieving section 562, converting section 564, and recording section 566. Storage 504 includes API parameters 570, file path identifiers 572, and authorization parameters 574.

Transmitting section 560 is the circuitry or instructions of controller 502 configured to transmit data. In at least some embodiments, transmitting section 560 is configured to transmit a requested value among a plurality of values stored in a first file path in response to determining that the request is for property data, and transmit requested data among application specific data stored in a second file path in response to determining that the request is not for property data. In at least some embodiments, transmitting section 560 utilizes information in storage 504, such as file path identifiers 572. In at least some embodiments, transmitting section 560 includes sub-sections for performing additional functions, as described in the foregoing flow charts. In at least some embodiments, such sub-sections are referred to by a name associated with a corresponding function.

Retrieving section 562 is the circuitry or instructions of controller 502 configured to retrieve data. In at least some embodiments, retrieving section 562 is configured to retrieve a first value through a first vehicle API, and retrieve a second value through a second vehicle API. In at least some embodiments, retrieving section 562 records information in storage 504, such as API parameters 570. In at least some embodiments, retrieving section 562 includes sub-sections for performing additional functions, as described in the foregoing flow charts. In at least some embodiments, such sub-sections are referred to by a name associated with a corresponding function.

Converting section 564 is the circuitry or instructions of controller 502 configured to convert data into a common format. In at least some embodiments, converting section 564 is configured to convert at least one of the first value or the second value from a proprietary format into a common format. In at least some embodiments, retrieving section 562 utilizes information in storage 504, such as file path identifiers 572. In at least some embodiments, converting section 564 includes sub-sections for performing additional functions, as described in the foregoing flow charts. In at least some embodiments, such sub-sections are referred to by a name associated with a corresponding function.

Recording section 566 is the circuitry or instructions of controller 502 configured to record data. In at least some embodiments, recording section 566 is configured to record the first value and the second value to a first file path among a plurality of values. In at least some embodiments, recording section 566 utilizes information in storage 504, such as authorization parameters 574. In at least some embodiments, recording section 566 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, unification of access to vehicle property data and HMI application specific data is performed by receiving, from an HMI application, a request to read data, determining whether the request is for property data, transmitting a requested value among the plurality of values stored in the first file path in response to determining that the request is for property data, and transmitting requested data among application specific data stored in a second file path in response to determining that the request is not for property data.

In at least some embodiments, unification of access to vehicle property data and HMI application specific data further includes retrieving a first value through a first vehicle API, retrieving a second value through a second vehicle API, converting at least one of the first value or the second value from a proprietary format into a common format, and recording the first value and the second value to a first file path among a plurality of values. In at least some embodiments, unification of access to vehicle property data and HMI application specific data further includes receiving, from an HMI application, a request to write data among the application specific data. In at least some embodiments, unification of access to vehicle property data and HMI application specific data further includes recording the data among the application specific data to the second file path in response to the request to write the data among the application specific data. In at least some embodiments, the request includes a file path identifier, and the determining is based on the file path identifier. In at least some embodiments, the first value is retrieved in response to a change notification received through the first vehicle API. In at least some embodiments, the first value is retrieved in response to the request to read data. In at least some embodiments, the request is received through a head unit API. In at least some embodiments, the first file path has a higher access restriction than the second file path. In at least some embodiments, unification of access to vehicle property data and HMI application specific data further includes changing the file path identifier of the first file path in response to a vehicle status. In at least some embodiments, the vehicle status is one of speed, automated driving, or emergency situation. In at least some embodiments, the first value is retrieved from a first vehicle sensor, and the second value is retrieved from a second vehicle sensor. In at least some embodiments, the first sensor is one of a speedometer, a fuel sensor, or a tachometer. In at least some embodiments, the first value is one of a vehicle speed, an amount of fuel, an engine RPM, or a number of connected devices. In at least some embodiments, the HMI application is one of a navigation application, a media application, or a user communication application. In at least some embodiments, the application specific data is one of account data or user information.

In at least some embodiments, unification of access to vehicle property data and HMI application specific data is performed by a processor executing instructions in accordance with the foregoing operations or a device comprising a controller including circuitry configured to perform the foregoing operations.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium having instructions recorded thereon that, in response to execution by one or more processors, cause performance of operations comprising:
receiving, from an Human Machine Interface (HMI) application, a request to read data;
determining whether the request is for property data;
transmitting a requested value among a plurality of values stored in a first file path in response to determining that the request is for property data; and
transmitting requested data among application specific data stored in a second file path in response to determining that the request is not for property data.

2. The computer-readable medium of claim 1, wherein the operations further comprise:
retrieving a first value through a first vehicle Application Programming Interface (API);
retrieving a second value through a second vehicle API;
converting at least one of the first value or the second value from a proprietary format into a common format; and
recording the first value and the second value to a first file path among the plurality of values.

3. The computer-readable medium of claim 2, wherein the operations further comprise receiving, from an HMI application, a request to write data among the application specific data.

4. The computer-readable medium of claim 3, wherein the operations further comprise recording the data among the application specific data to the second file path in response to the request to write the data among the application specific data.

5. The computer-readable medium of claim 2, wherein the request includes a file path identifier, and the determining is based on the file path identifier.

6. The computer-readable medium of claim 2, wherein the first value is retrieved in response to a change notification received through the first vehicle API.

7. The computer-readable medium of claim 2, wherein the first value is retrieved in response to the request to read data.

8. The computer-readable medium of claim 1, wherein the request is received through a property manager API.

9. The computer-readable medium of claim 1, wherein the first file path has a higher access restriction than the second file path.

10. The computer-readable medium of claim 1, wherein the operations further comprise changing the file path identifier of the first file path in response to a vehicle status.

11. The computer-readable medium of claim 1, wherein the vehicle status is one of speed, automated driving, or emergency situation.

12. The computer-readable medium of claim 1, wherein the first value is retrieved from a first vehicle sensor, and the second value is retrieved from a second vehicle sensor.

13. The computer-readable medium of claim 1, wherein the first sensor is one of a speedometer, a fuel sensor, or a tachometer.

14. The computer-readable medium of claim 1, wherein the first value is one of a vehicle speed, an amount of fuel, an engine RPM, or a number of connected devices.

15. The computer-readable medium of claim 1, wherein the HMI application is one of a navigation application, a media application, or a user communication application.

16. The computer-readable medium of claim 1, wherein the application specific data is one of account data or user information.

17. A method comprising:
receiving, from an HMI application, a request to read data;
determining whether the request is for property data;
transmitting a requested value among the plurality of values stored in the first file path in response to determining that the request is for property data; and
transmitting requested data among application specific data stored in a second file path in response to determining that the request is not for property data.

18. The method of claim 17, further comprising retrieving a first value through a first vehicle API;
retrieving a second value through a second vehicle API;
converting at least one of the first value or the second value from a proprietary format into a common format; and
recording the first value and the second value to a first file path among a plurality of values.

19. The method of claim 17, further comprising receiving, from an HMI application, a request to write data among the application specific data.

20. A device comprising:
a controller including circuitry configured to perform operations including
receiving, from an HMI application, a request to read data,
determining whether the request is for property data,
transmitting a requested value among the plurality of values stored in the first file path in response to determining that the request is for property data, and
transmitting requested data among application specific data stored in a second file path in response to determining that the request is not for property data.
